(19) United States
(12) Patent Application Publication
(10) Pub. No.: US 2025/0308142 A1
(43) Pub. Date: Oct. 2, 2025

(54) SCALABLE 3D SCENE REPRESENTATION USING NEURAL FIELD MODELING

(71) Applicant: DOLBY LABORATORIES LICENSING CORPORATION

(72) Inventors: Guan-Ming SU, Fremont, CA (US); Peng YIN, Ithaca, NY (US); Anustup Kumar Atanu CHOUDHURY, Campbell, CA (US); Taoran LU, Santa Clara, CA (US)

(73) Assignee: DOLBY LABORATORIES LICENSING CORPORATION, (US)

(21) Appl. No.: 19/109,544

(22) PCT Filed: Sep. 5, 2023
(86) PCT No.: PCT/US23/73486

§ 371 Date: Mar. 6, 2025

Related U.S. Application Data
(60) Provisional application No. 63/404,885, filed on Sep. 8, 2022.

(51) Int. Cl. G06T 15/20; G06T 19/20

(52) U.S. Cl. CPC G06T 15/20; G06T 19/20; G06T 2219/2012; G06T 2219/2016

(57) ABSTRACT

Methods, systems, and bitstream syntax are described for a scalable 3D scene representation. A general framework presents a dual-layer architecture where a base layer provides a baseline scene representation, and an enhancement layer provides enhancement information under a variety of scalability criteria. The enhancement information is coded using a trained neural field. Example systems are provided using a PSNR criterion and a baseline multi-plane image (MPI) representation. Examples of bitstream syntax for metadata information are also provided.

### CROSS-REFERENCE TO RELATED APPLICATIONS

This application claims the benefit of priority from U.S. Provisional Application Ser. No. 63/404,885 filed on 8 Sep. 2022, which is incorporated by reference herein in its entirety.

### TECHNOLOGY

The present document relates generally to images. More particularly, an embodiment of the present invention relates to a scalable 3D scene representation using a dual layer approach where information of an enhancement layer is modeled using a neural field.

### BACKGROUND

In recent years there has been an increased interest for the efficient modeling and representation of 3D scenes. 3D scenes may be used in a variety of applications, including volumetric imaging, virtual reality, or augmented reality. Deep learning techniques have shown promising results in 3D scene representation and reconstruction; however, not all devices can handle the computation load associated with such approaches. As appreciated by the inventors here, it is desirable to provide scalable 3D scene representation under a variety of scalability criteria, thus improved techniques for 3D scene representation are described herein.

The term “metadata” herein relates to any auxiliary information transmitted as part of a coded bitstream and assists a decoder to render a decoded image or a 3D scene. Such metadata may include, but are not limited to, color space or gamut information, reference display parameters, camera parameters, neural network parameters, and the like.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF THE DRAWINGS

An embodiment of the present invention is illustrated by way of example, and not in way by limitation, in the figures of the accompanying drawings and in which like reference numerals refer to similar elements and in which:

FIG. 1A depicts an example of an encoder for a scalable 3D scene representation under a general scalability framework according to an embodiment of this invention;

FIG. 1B depicts an example of decoder for a scalable 3D scene representation under a general scalability framework according to an embodiment of this invention;

FIG. 1C depicts an example of an encoder for a scalable 3D scene representation under a PSNR criterion according to an embodiment of this invention;

FIG. 1D depicts an example of decoder for a scalable 3D scene representation under a PSNR criterion according to an embodiment of this invention;

FIG. 2A depicts an example of an encoder for a scalable 3D scene representation under a PSNR criterion and a multi-plane image (MPI) representation according to an embodiment of this invention; and

FIG. 2B depicts an example of decoder for a scalable 3D scene representation under a PSNR criterion and an MPI representation according to an embodiment of this invention.

### DESCRIPTION OF EXAMPLE EMBODIMENTS

Example embodiments that relate to a scalable 3D-scene representation are described herein. In the following description, for the purposes of explanation, numerous specific details are set forth in order to provide a thorough understanding of the various embodiments of present invention. It will be apparent, however, that the various embodiments of the present invention may be practiced without these specific details. In other instances, well-known structures and devices are not described in exhaustive detail, in order to avoid unnecessarily occluding, obscuring, or obfuscating embodiments of the present invention.

### SUMMARY

Example embodiments described herein relate to scalable 3D-scene representation. In an embodiment, in an encoder, to generate a scalable 3D scene representation, a processor:
accesses a first set of images in a first format (102) for a scene;
generates a first 3D scene representation (107) for the scene based on the first set of images;
accesses a second set of images in a second format (104) for the scene;
generates a second 3D scene representation (112) for the scene based on the second set of images, wherein the second 3D representation is better than the first 3D scene representation according to one or more quality criteria;
using a set of original viewing positions and a set of novel viewing positions, generates output image residuals (122) based on the first 3D scene representation and the second 3D scene representation;
trains a residual neural field network (125) using the output image residuals to generate predicted residual images approximating the output image residuals;
transmits the first 3D scene representation (107) for the scene as a base layer; and transmits information about the trained residual neural field network as an enhancement layer.

In an embodiment, in a decoder, to generate an output 3D scene, a processor:
receives a base layer bitstream (107) comprising a first 3D scene representation (107) for a scene;
receives an enhancement layer bitstream (127) comprising information to reconstruct a trained residual neural field network;
given a viewer position:
   generates a first 3D output (132) of a scene based on the first 3D scene representation;
   generates image residuals (145) using the viewer position and the trained residual neural field network; and
   combines the first 3D output of the scene and the image residuals to generate an enhanced 3D output of the scene.

### 3D Scene Representations and Neural Fields

### Introduction

There are multiple 3D scene representation models, including the multi-view plus depth (MVD) method (Ref. [6]), multi-plane imaging (MPI) (Ref. [5]), and neural radiance field (NeRF) (Ref. [2]) representation. Among all of those methods, there are three major evaluation criteria: (1) their computation complexity at training and testing time, (2) bit size (bandwidth requirement) of scene representation and model size, and (3) 3D scene reconstruction quality. In practice, there are multiple end-devices, and applications need to address the computation capability and required 3D reconstructed quality of the end-application while preserving communication bandwidth. Some devices can only afford a low computation-load, but their users can accept lower quality. For high-end devices, adding more computation to achieve better quality is feasible. To cover a wide spectrum of needs and requirements, embodiments herein propose a dual-layer system with a base layer (BL) to satisfy a baseline set of requirements and an enhancement layer (EL) to enhance user experience. The proposed framework can also incorporate a variety of scalability criteria based on peak signal to noise ratio (PSNR), dynamic range, color gamut, spatial resolution, temporal frame rate, and the like.

As an example, for the base layer one may adopt the MPI representation, due to its ultra-low decoding computation. Such a base layer would ensure a broad deployment of the encoded bit stream to multiple devices, and it would maintain a baseline quality. However, MPI lacks the ability to provide lots of specular highlights (non-Lambertian; for example, transparent materials belong to the non-Lambertian family). To provide those specular highlights, one can encode the difference between a 3D scene with specular highlights and MPI in the enhancement layer using neural field coding. The base layer can be coded (compressed) using conventional codec techniques, such as AVC, HEVC, VVC, AV1, and the like, while the enhancement layer can carry neural-network coefficients representing the neural field. Once a device has more computation power, one can decode the enhancement and add it on top of the base layer to provide better rendering quality.

Some other benefits compared to using single-layer solutions neural network, such as NeRF, to code a 3D scene directly include the following. Neural network solutions, such as NeRF, or generally speaking, an MLP (a Multilayer Perceptron), require scene specific training which can be an issue for some application. In contrast, MPI can use a pretrained network. If MLP is only used for residue, the neural network (NN) can be greatly simplified, and training time should be dramatically reduced.

For an MLP, such as NeRF, the model size is about 5 Mbytes per image scene. A straightforward transmission of such a model for a video sequence can be a big burden to the network. Furthermore, the compressibility for such a NN representation is still under investigation. If MLP is used for the residue layer, the transmission bitrate can be dramatically reduced.

In certain embodiments, the enhancement layer is out of the coding loop. Thus, one can offer a quality enhancement by simply adding NN residual information to the scene rendered using just the base layer. In addition, the out of the coding loop operation does not require a bit-exact process. The platform can select either floating point, or fixed point operations to fit its computational environment.

In an embodiment, without limitation, the NN coefficients can be carried within the bitstream or downloaded from external means, for example, using syntax defined in Ref. [13] (see also Ref. [4]).

Scalability allows one to apply for a variety of diverse quality criteria to generate the enhancement layer, including:
PSNR: the 3D rendering quality can be improved by adding enhancement layer residuals on top of a lower quality base layer;
Dynamic range: one can enhance the dynamic range of the rendered image by adding an enhancement layer residual on top of a standard dynamic range (SDR) 3D scene to generate a high dynamic range (HDR) 3D scene;
Color gamut: one can enhance the color gamut by adding an enhancement layer residual on top of a narrower SDR color gamut 3D scene to generate a wider color gamut 3D scene;
Spatial resolution: using an upscaled version of the base layer, one can add the enhancement layer information to enhance the details of a final scene at a higher resolution than the base layer resolution;
Temporal frame rate: one can apply a frame rate interpolation on the base layer, then add the neural-field residual to generate an output at a higher frame rate;
Any combinations of the above scalability criteria

### Neural Fields

The term ‘neural fields’ denotes coordinate-based, fully-connected neural networks (Ref. [1]). A neural network connects many layers of artificial neurons to learn to non-linearly map a fixed-size input to a fixed-size output. A multi-layer perceptron (MLP) neural network can approximate any function through their learned parameters. Thus, a neural field can be built from a multi-layer perceptron (MLP). In the rest of this discussion, the terms MLP and neural field will be used interchangeably.

An end-to-end MLP network consists of K layers of weights {Wₖ} and bias {bₖ} parameters. Denote those parameters as Φ={{Wₖ}, {bₖ}}. This MLP network takes input x and output ŷ, where

$$\hat{y} = M L {P}_{Φ} ( x ) \qquad ( 1 )$$

Having a ground truth signal y^{gt}, the formal problem formulation to optimize the parameter set Φ is given by:

$${Φ}^{*} = arg {min}_{Φ} D ( \hat{y} , {y}^{gt} ) , \qquad ( 2 )$$

where D( ) denotes a loss/error function.

In some 3D scene representations, such as NeRf (see Ref. [2]), the input x consists of spatial locations (x, y, z) and the viewing direction (θ, ϕ), and outputs the volume density (σ) and view dependent emitted radiance (r, g, b) at those coordinates.

### Positional Encoding

Neural fields suffer from a loss of frequency details. To address this issue, applying positional encoding is a common solution. In positional encoding, the network inputs are mapped to a higher dimensional space. This is because neural networks are more biased towards learning lower frequency functions. Thus, a typical neural network is not able to represent high frequency variations in color and geometry. For neural scene representation, the performance of a neural network is significantly improved by mapping the position coordinates p from R to R^{2L} where L is the number of frequencies. A typical mapping y acting on a coordinate p can be represented as:

$$γ ( p ) = [ sin ( {2}^{{l}_{0}} π p ) cos ( {2}^{{l}_{0}} π p ) sin ( {2}^{{l}_{1}} π p ) cos ( {2}^{{l}_{1}} π p ) … sin ( {2}^{{l}_{L - 1}} πp ) cos ( {2}^{{l}_{L - 1}} π p ) ] , \qquad ( 3 )$$

where {l₀, l₁, . . . , l_{L-1}} are integers. In a typical setting, lₖ=k.

Alternatively, one may apply parametric encoding, that is, arrange additional trainable parameters (beyond weights and biases) in an auxiliary data structure: such as grid, or a tree, and to look-up and (optionally) interpolate these parameters depending on the input vector.

Additional solutions to help alleviating the high frequency modelling, include a using periodic function as the activation function (see SIREN in Ref. [7]).

### Forward Mapping

In some applications, the output from an MLP is not the direct required result and needs another mapping. For example, in NeRF, the output from MLP is (σ, r, g, b) at the coordinate query point (x, y, z, θ, ϕ). To construct a projected 2D image, a volume rendering is needed by querying all particles along each ray and computing the final rendered RGB value.

In the proposed embodiments, the output from the neural residual network is already the rendered RGB residual. The RGB residual can be directly added on top of the rendered novel view from the base layer. Next, different architecture designs will be discussed.

A general framework for scalable 3D representation

Consider a set of images, {I₍ₜ_{^{g}}₎^{g}}, capturing the same scene from several different viewing positions, denoted as {t^{g}}. In an embodiment, the collected image set can be used to construct a first 3D scene representation algorithm R_{Φ}_{_{b}}^{b} (with parameter Φ_{b}) to be used as base layer. Given a query viewing position, one then can render an image of the scene at the original viewing positions {t^{g}} and novel viewing positions {tⁿ}. Denote the rendered image at {t^{g}} as {Î₍ₜ_{^{g}}₎^{b}}, and at {tⁿ} as {Î₍ₜ_{ⁿ}₎^{b}}. The base layer should provide the minimal (base level) quality of the 3D representation, suited for a typical decoding environment.

Next, one can use a second 3D scene representation algorithm that can offer an increased level of quality over the base level. As discussed before, and will be discussed in more details later, such increased level of quality may include improved PSNR, higher bit depth, wider color gamut, and the like. Depending on the scalability criterion, one may apply the same training dataset or a different training data set to get a model R_{Φ}_{ₛ}^{s} (with parameters Φₛ). As before, one can render the image at the original viewing positions {t^{g}} and novel viewing positions {tⁿ} using R_{Φ}_{ₛ}^{s}. Denote the rendered image at {t^{g}} as {\hat{Î}₍ₜ_{^{g}}₎^{s}}, and at {tⁿ} as {Î₍ₜ_{ⁿ}₎^{s}}.

In an embodiment, the residual image can be generated by taking the rendering difference from the first base 3D scene representation R_{Φ}_{_{b}}^{b} and the second 3D scene representation R_{Φ}_{ₛ}^{s}. At original viewing positions {t^{g}} and novel view positions {tⁿ}, one has

$${\hat{I}}_{( {t}^{g} )}^{e} = {\hat{I}}_{( {t}^{g} )}^{s} - {\hat{I}}_{( {t}^{g} )}^{b} , \qquad ( 4 )$$

$${\hat{I}}_{( {t}^{n} )}^{e} = {\hat{I}}_{( {t}^{n} )}^{s} - {\hat{I}}_{( {t}^{n} )}^{b} .$$

In an embodiment, both sets of residual images, {Î₍ₜ_{^{g}}₎^{e}} and {Î₍ₜ_{^{g}}₎^{s}} are used to train a third neural residual network MLP R_{Φ}_{ᵣ}^{r} (with parameter Φᵣ). Note that in this case, the MLP takes an image coordinate (x, y) with positional encoding and viewing position t as input; and outputs RGB values for pixel locations (x, y) as Î₍ₜ₎^{r}(x, y).

$${\hat{I}}_{( t )}^{r} ( x , y ) = M L {P}_{{Φ}_{r}} ( γ ( x ) , γ ( y ) , t ) , \qquad ( 5 )$$

where γ( ), as discussed earlier, denotes a positional encoding function.

Unlike NeRF, which needs volume rendering, the neural residual does not need forward mapping to obtain the rendered 2D image. The output from the MLP is already in the RGB domain. The main goal of the neural residual network is to take any viewing position {t} and output the predicted residual image {Î₍ₜ₎^{r}}. The optimization process can be formulated as follows:

$${Φ}_{r}^{*} = arg {min}_{{Φ}_{r}} D ( {\hat{I}}_{( t )}^{τ} , {\hat{I}}_{( t )}^{e} ) . \qquad ( 6 )$$

In an embodiment, the base model parameter set, Φ_{b}, and the residual model parameter set, Φᵣ, can be separately compressed by MPEG NNC (Ref. [4]). Other embodiments may use 3D representations that don't involve neural networks. For example, the base model parameter set, Φ_{b}, may represent multiview texture (MVC), multiview texture plus depth (MVC+D or MVD), or an MPI format. Those formats can be used to render a 3D scene and can be compressed using existing single-layer or multi-layer codecs, like AVC, HEVC, VVC, MIV (MPEG Immersive Video), and the like.

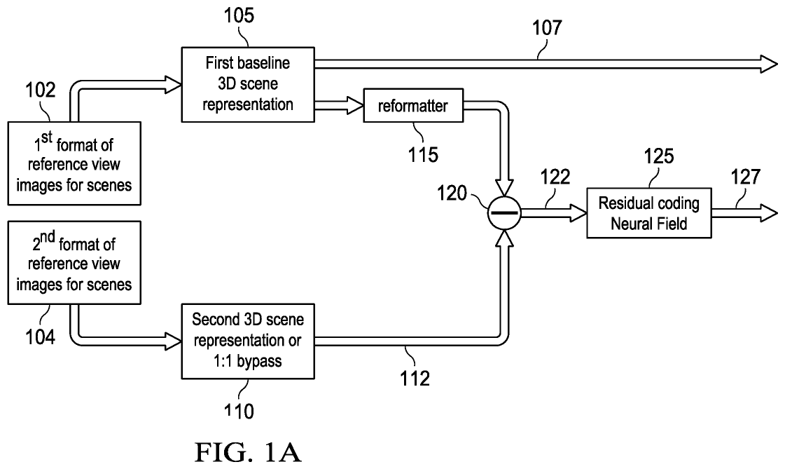

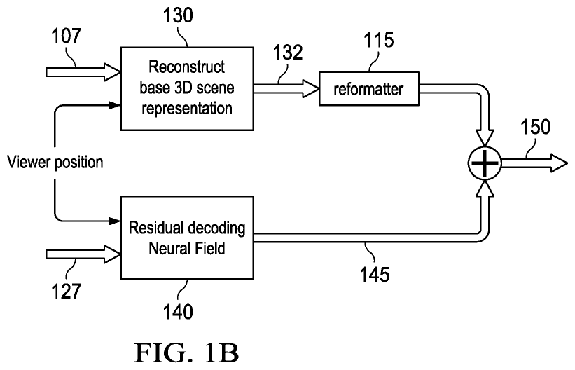

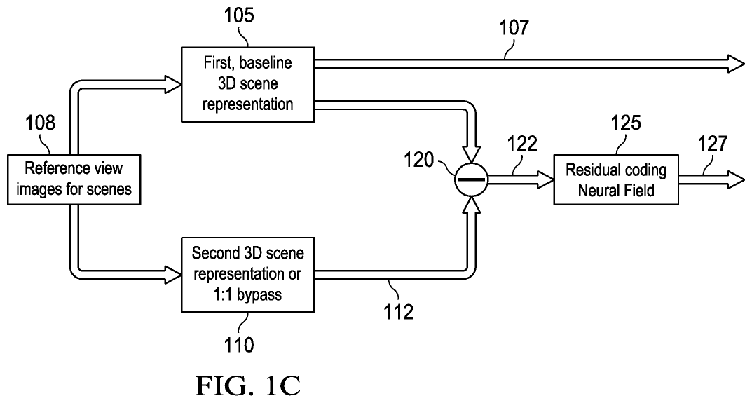

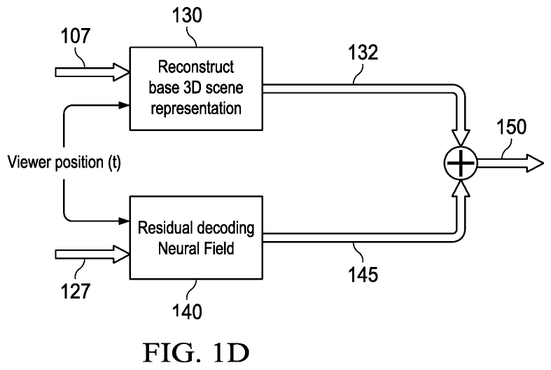

FIG. 1A depicts an example processing pipeline for encoding a scalable 3D representation using a generic framework that supports a variety of scalability criteria, such as:
a. PSNR scalability
b. Dynamic range scalability
c. Color gamut scalability
d. Spatial resolution scalability
e. Temporal frame rate scalability

As depicted in FIG. 1A, the base layer comprises a first unit (105) to generate a first baseline 3D scene representation (107). Input to this unit is a first set of reference input images (102) for a scene, in a first format. This 3D scene representation may be further compressed using either traditional image and video coding tools or alternative NN-representation coding tools (not shown).

To generate the enhancement layer (127), a second set of reference input images (104) for the same scene, but in a second format, is fed to a second unit (110) which will generate a second 3D representation (112). For example, depending on the scalability criterion and without loss of generality, the two sets of reference images (102, 104) may represent:
a. PSNR scalability: the first set of images is the same as the second set of images;
b. Dynamic range scalability: the first set of images are in SDR, and the second set of images are in HDR;
c. Color gamut scalability: the first set of images are in R.709, and the second set of images are in R.2020;
d. Spatial resolution scalability: the first set of images are in 1080p, and the second set of images are in 2160p;
e. Temporal frame rate scalability: the first set of images are in 24 fps, and the second set of images are 48 fps;
   In unit 110, for the second 3D scene representation, a 1:1 bypass might be used if the rendered scene is in an original camera position where ground-truth images are available. In other words, using the 1:1 bypass, one can take advantage of having the ground truth image at pose {t^{g}} by directly using the ground truth image to generate the residual, instead of using the second model (110), whose output might still contain artifacts/distortion.

As depicted in FIG. 1A, in some embodiments, a reformatter (115) may be needed when there is spatial and/or temporal misalignment between the base layer and the enhancement layer outputs (107 and 112) (e.g., in cases d) and e) discussed above). For spatial resolution scalability, the reformatter may perform spatial up-scaling or down-scaling. For temporal frame rate scalability, the reformatter may drop frames or perform inter-frame interpolation. This reformatter is used in both encoder and decoder (see FIG. 1B). In some embodiments, the reformatter may be employed in the enhancement layer, after the second/enhancement layer representation unit (110).

Given the two scene representations, a residual (122) is generated by residual generator (120), representing their difference. All residuals from different views are encoded by neural field (125). The neural-network representation of residual neural field (125) is compressed and transmitted as neural network residual bitstream output (127).

At the decoder side, as depicted in FIG. 1B, a decoder receives bitstreams (107) and (127) representing the baseline and enhancement information. Note that if bitstream (107) was compressed prior to transmission, it should also be suitably decompressed in the decoder (not shown). Some decoders may simply use only the baseline information and ignore any enhancement information. As depicted in FIG. 1B, given a user's specified viewing position to render a scene, a base layer unit (130) will reconstruct a rendered baseline view (132). Depending on the scalability criterion, as discussed earlier, if the decoder will use residual information, then the baseline view (132) may need to be processed by the reformatter (115). The enhancement layer bitstream (127) will be decoded along with the user's viewer position input to render the residual (145) generated using neural field (140). The output from the reformatter will be added to the residual to generate the refined novel view (150).

In an embodiment, one may desire to reduce the computational complexity of generating the neural field (125) and/or reducing the neural-field model size, for example, by training neural field 125 using input residuals (122) of lower spatial resolution. This step of reducing the spatial resolution of the residuals can be a separate processing unit (not shown) positioned after the residual generator (120) and before the residual neural field (125), or it can be absorbed by the structure of the residual field (125). In the decoder, one can add a spatial-upscaling unit after neural field 140. Alternatively, since a neural field is a continuous function block, during inferencing, one can query higher resolution outputs even if the neural residual network is trained using lower resolution grid data. Thus, the residual decoding neural field (140) can absorb the spatial interpolation operation and there is no need for a separate spatial/temporal interpolation module.

### Scalability Using a PSNR Criterion

FIG. 1C and FIG. 1D depict a simplified version of FIG. 1A and FIG. 1B when the scalability criterion is PSNR. As depicted in FIGS. 1C and 1D, the reformatter (115) is removed and the encoder is trained based on a single set of reference views and scenes (108).

In FIG. 1D, given a novel viewing position, t, the base 3D scene representation R_{Φ}_{_{b}}^{b} will output the base image (132) as Î₍ₜ₎^{r}, and the neural residual model (140) will output the predicted residual (145) as I′ (+). The final refined rendered image (150) will be the combination of the two images:

$${\hat{I}}_{( t )}^{f} = {\hat{I}}_{( t )}^{b} + {\hat{I}}_{( t )}^{r} . \qquad ( 7 )$$

In an embodiment, the baseline representation may be based on the multi-view and depth (MVD) format. In such a scenario, the original view images are the input encoded images, and the novel view images are the Depth Image Based Rendering (DIBR) generated images (Ref. [6]).

In another embodiment, the baseline representation may be based on the MPI representation (Ref. [5]). It is noted that the term “MPI” is typically used to handle face-forward scenes. When dealing with 360 degree video, the term MSI (Multi-sphere Imaging) is used (Ref. [8]). But the concept is the same. Next, as an example, and without limitation, additional details will be provided for the MPI representation, assuming a face-forward scene, where all camera poses are in the same plane. As an example, only image scenes will be considered, but a similar concept can be applied to video scenes as well.

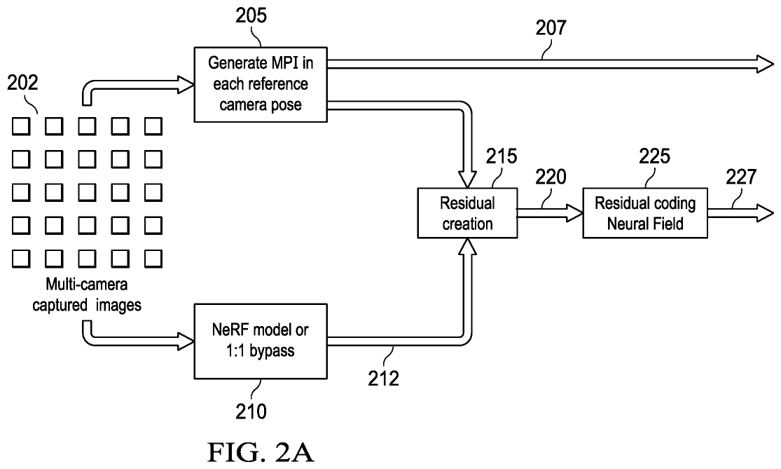

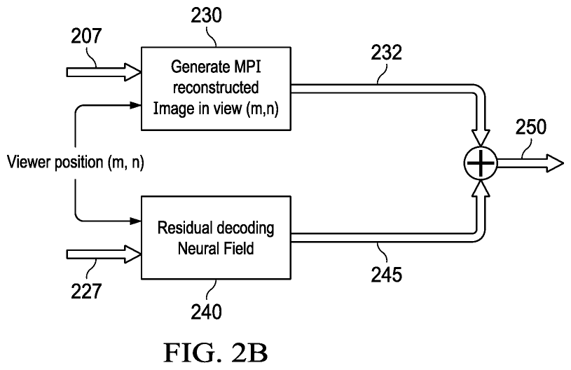

FIG. 2A depicts an example embodiment of an encoder for a scalable 3D scene representation under a PSNR criterion and an MPI representation. Given reference multi-camera captured images (202), the base layer (207) contains MPI bitstreams. To reduce the burden at the decoder, for each camera position (a camera pose or view) tϵ{t^{g}}, in unit (205), a pretrained NN may be used to convert an image (I₍ₜ_{^{g}}₎^{g}) into D-layer MPI format (Cᵢ^{(s)}, Aᵢ^{(s)}) for i=0, . . . , D−1, where Cᵢ^{(S)} is the i-th texture layer and Aᵢ^{(s)} is the i-th transparent layer. The pre-processing steps to convert MPIs from multi-camera poses to fit into conventional codecs such as AVC, HEVC, and VVC, and the like are not shown in this diagram. For each novel view position tϵ{tⁿ}, a pre-defined number (typically it's 4 or 8) of nearest original camera views are selected for interpolation and the set is denoted as Tₜ. Each selected original view, s, will be warped to novel view position, t, as a new MPI representation: (Cᵢ^{(s→t)}, Aᵢ^{(s→t)}) for i=0, . . . , D−1. The warping process for each layer (Cᵢ^{(s)}, Aᵢ^{(s)}, from the current viewpoint position s to new viewpoint position t may be expressed as:

$${C}_{i}^{( s \to t )} = {T}_{s , t} ( σ {d}_{i} , {C}_{i} ) , \qquad ( 8 )$$

$${A}_{i}^{( s \to t )} = {T}_{s , t} ( σ {d}_{i} , {A}_{i} ) .$$

The warping function, T_{s,t}( ), may be represented as

$$[ \begin{matrix}{u}_{s} \\ {v}_{s} \\ 1\end{matrix} ] = {K}_{s} ( R - \frac{t {n}^{T}}{a} ) {( {K}_{t} )}^{- 1} [ \begin{matrix}{u}_{t} \\ {v}_{t} \\ 1\end{matrix} ] , \qquad ( 9 )$$

where (uₛ, vₛ) is the pixel coordinate at pose s and (uₜ, vₜ) is the pixel coordinate at pose t. Kₛ and Kₜ are the camera intrinsic camera models for reference view and target view. R and t are the extrinsic camera models for rotation and translation. n is the normal vector [0 0 1]^{T}. a is the distance to a plane that is front-to-parallel to the source camera at depth σdᵢ.

The rendered image from s to t, I^{(s→t)}, can be computed as the warped texture and alpha channel:

$${W}_{i}^{( s \to t )} = ( {A}_{i}^{( s \to t )} \cdot {\prod }_{j = i + 1}^{D - 1} ( 1 - {A}_{j}^{( s \to t )} ) ) , \qquad ( 10 )$$

$${I}^{( s \to t )} = {\sum }_{i = 0}^{D - 1} {C}_{i}^{( s \to t )} {W}_{i}^{( s \to t )} .$$

One can also sum up all transparent layers, which will be used in the fusion process.

$${A}^{( s \to t )} = {\sum }_{i = 0}^{D - 1} {A}_{t}^{( s \to t )} . \qquad ( 11 )$$

The novel view is the weighted combination from the warped selected neighbors Tₜ is given by (Ref. [9]):

$${\hat{I}}_{( t )}^{b} = \frac{{\sum }_{s ∈ {T}_{t}} {α}^{( s \to t )} {A}^{( s \to t )} {I}^{( s \to t )}}{{\sum }_{s ∈ {T}_{t}} {α}^{( s \to t )} {A}^{( s \to t )}} . \qquad ( 12 )$$

The weighting factor is expressed as

$${α}^{( s \to t )} = {e}^{- \frac{f}{D {d}_{N}} {‖ {p}_{s} - {p}_{t} ‖}_{2}} , \qquad ( 13 )$$

where f here represents the camera focal length and pₛ and pₜ represent the poses of camera s and the novel view t.

In an embodiment, the enhancement layer (227) contains a neural network coding bitstream which comprises NN MLP model parameters (e.g., for model 225). The input to the NN MLP (225) is (x, y, m, n), where (x, y) is pixel location of an image and (m, n) denotes the pose coordinates. The output of NN MLP is RGB value for any given (x, y, m, n). At the encoder side, one needs to train the MLP per NN residue scene. The training residue images (220) may be generated (e.g., in unit 215) using reference views and novels views as follows:
First, apply a second 3D scene representation algorithm (e.g., NeRF 210) using the same dataset to get the model R_{Φ}_{ₛ}^{s} (with parameter Φₛ). One can render the image at the original viewing positions {t^{g}} and novel viewing positions {tⁿ} using R_{Φ}_{ₛ}^{s}. Denote the rendered image (212) at {t^{g}} as {Î₍ₜ_{^{g}}₎^{s}}, and at {tⁿ} as {Î₍ₜ_{ⁿ}₎^{s}}.
for original camera pose t^{g}, the residue image (220) (Î₍ₜ_{^{g}}₎^{b})=original camera captured image I₍ₜ_{^{g}}₎^{g}—rendered image by camera MPIs (Î₍ₜ_{^{g}}₎^{b}), i.e., {Î₍ₜ_{^{g}}₎^{e}}={I₍ₜ_{^{g}}₎^{g}}−Î₍ₜ_{^{g}}₎^{b}
for novel pose tⁿ, the residue image (220) (Îₜ_{ⁿ}₎^{e})=rendered image by NeRF model (210) (Îₜ_{ⁿ}₎^{s})—rendered image by multi-camera MPIs (Îₜ_{ⁿ}₎^{b}, i.e., Î₍ₜ_{ⁿ}₎^{e}=Î₍ₜ_{ⁿ}₎^{s}−Î₍ₜ_{ⁿ}₎^{b}
   The residue images (220) {Î₍ₜ₎^{e}} are then used for NN 225 to train MLP function R_{Φ}_{ᵣ}^{r} (with parameter Φr):

$${\hat{I}}_{( t )}^{r} ( x , y ) = {MLP}_{{Φ}_{r}} ( x , y , m , n ) . \qquad ( 14 )$$

The network parameters can be found via the optimization

$${Φ}_{r}^{*} = arg {min}_{{Φ}_{r}} D ( {\hat{I}}_{( t )}^{r} , {\hat{I}}_{( t )}^{e} ) . \qquad ( 15 )$$

This residue images generation does not take compression artifact into consideration. If compression is taken into consideration, one more parameter can be added into the NN MLP input function, for example, (x, y, m, n, Qp), where, for example, Qp is the average quantization parameter used for coding the base layer. Additional parameters can be used to indicate quality levels too. When generating the training data, the MPI rendered image can be replaced by compressed MPI rendered images.

FIG. 2B depicts an example embodiment of the corresponding decoder. Given baseline input 207, for any given novel pose (m, n), the base layer NN (230) decodes the required multiple (for example, four) camera pose MPIs and renders a base layer image (232). For the enhancement layer, given input 227, the residue image (245) is generated using a trained MLP (240). Then, the base layer (232) and enhancement layer (245) are added to generate the final image (250).

An example of an MLP function is shown as follows using PyTorch code:

TABLE 1
Example of neural field for residue coding

```
import torch
from torch import nn
class MLP(nn.Module):
  ‘‘‘
  Multilayer Perceptron for regression.
  ’’’
  def _{——}init_{——}(self, in_dim, out_dim):
    super( )._{——}init_{——}( )
    self.layers = nn.Sequential(
      nn.Linear(in_dim, 256),
      nn.ReLU( ),
      nn.Linear(256, 128),
      nn.ReLU( ),
      nn.Linear(128,64),
      nn.ReLU( ),
      nn.Linear(64, 32),
      nn.ReLU( ),
      nn.Linear(32, 16),
      nn.ReLU( ),
      nn.Linear(16, out_dim),
      nn.Sigmoid( ) # Compresses the input to range [0,1]
    )
  def forward(self, x):
    ‘‘‘
      Forward pass
    ’’’
    return self.layers(x)
```

During the training, the loss function can be defined using the normalized root mean squared error. Other loss functions can also be applied.

```
def loss_function(targets,outputs): # Normalized root mean squared error
  # Source:
  https://pytorch.org/docs/stable/generated/torch.linalg.norm.html
    return torch.linalg.norm(targets-outputs)/torch.linalg.norm(targets)
```

As an example, in an embodiment, for the training parameters: learning rate is 1e-3, and Adam optimization (a replacement optimization algorithm for stochastic gradient descent for training deep learning models) is used.

In an alternative embodiment, the base layer 3D representation can be a baseline

NeRF with a smaller model size, and the enhancement layer can be created via a more advanced (or higher precision) NeRF.

The input x of each NeRF consists of the spatial location (x, y, z) and the viewing direction (θ, ϕ), and outputs the volume density (G) and view dependent emitted radiance (r, g, b) at those coordinates.

For each viewing direction, one generates the rendered base image using a smaller model NeRF with parameter Φ_{b}:

$${\hat{I}}_{( t )}^{b} ( x , y ) = {MLP}_{{Φ}_{b}} ( x , y , z , θ , ϕ ) . \qquad ( 16 )$$

Using a smaller model NeRF with parameter Φₛ one can render a better quality image as

$${\hat{I}}_{( t )}^{s} ( x , y ) = {MLP}_{{Φ}_{s}} ( x , y , z , θ , ϕ ) . \qquad ( 17 )$$

The residual (e.g., 220) can be generated using original and novel views as follows:
For original camera pose t^{g}, the residue image (Î₍ₜ_{^{g}}₎^{e})=original camera captured image I₍ₜ_{^{g}}₎^{g}—rendered image by NeRF model MLP_{Φ}_{_{b}}(Î₍ₜ_{^{g}}₎^{b}), i.e., Î₍ₜ_{^{g}}₎^{e}=Î₍ₜ_{^{g}}₎^{g}−Î₍ₜ_{^{g}}₎^{b}
for novel pose tⁿ, the residue image (Î₍ₜ_{ⁿ}₎^{e})=rendered image by NeRF model MLP_{Φ}_{ₛ} as Î₍ₜ_{ⁿ}₎^{b}—rendered image by NeRF model MLP_{Φ}_{_{b}} as Î₍ₜ_{ⁿ}₎^{e}=Î₍ₜ_{ⁿ}₎^{s}−Î₍ₜ_{ⁿ}₎^{b}
   Note: Using the 1:1 bypass, one can take the advantage of having the ground truth image at pose {t^{g}} by directly using the ground truth image to generate the residual, instead of using the bigger NeRF model, which might still contain artifacts/distortion.

The neural residual network, MLP_{Φ}_{ᵣ}, can be trained using a method similar to the one mentioned for the MPI base layer.

In another embodiment, the base 3D representation can be generated using a scene-independent NeRF, such as PixelNeRF (Ref. [3]). The training procedure for such a scenario will be the same as the one for the scene-dependent NeRF discussed earlier.

### Messaging Considerations

The proposed approach is out of the coding loop. In an embodiment, syntax related to the system parameters may be communicated using metadata, such as supplementary enhancement information (SEI) used in the MPEG video coding standards. The syntax can also be carried as part of the video program sequence (VPS), the slice program sequence (SPS), the picture program sequence (PPS), the picture header, the slice header, and the like.

For example, an SEI message can carry information for the camera, the base layer, and the enhancement layer. The camera information should include camera parameters and camera position. For the base layer, since the base layer bitstream is the codec bitstream, one only needs to signal the extra information that the codec bitstream does not carry. Such information may include the base layer representation, such as MPI, MVD, and the like. For each input representation, some additional information may be needed. For example, for MPI, one may need to communicate the number of cameras, number of MPI layers, and the tiles-assembly. For the enhancement layer, syntax elements need to specify the NN MLP parameters. One can carry the NN parameters by external means or by using neural network represented by the ISO/IEC 15938-17 bitstream. As in NNPFC SEI (Ref. [10]), the enhancement layer information can include the input and output formatting information.

Table 2 provides an example SEI message to communicate syntax parameters related to a neural field used in a scalable 3D scene representation. To avoid duplication, only additional information is listed, that is, information not carried in the NNPFC SEI. Descriptor information (e.g., ue(v), u(n), and the like) is defined the same as in NNPFC SEI.

TABLE 2
Example of SEI messaging for scalable 3D scene representation

| | Descriptor |
|---|---|
| 3D_nn_residue_dual_layer_info( payloadSize ) { | |
| nnr_purpose_idc /*specified for output: 5 bit mapping: 0^{th} bit: PSNR quality; 1^{st} | ue(v) |
| bit: dynamic range mapping; 2^{nd} bit: color gamut; 3^{rd} bit: spatial resolution 4^{th} bit: | |
| temporal frame rate */ | |
| if (nnr_purpose_idc&0x08) { | |
| nnr_output_pic_width_in_luma_samples | ue(v) |
| nnr_output_pic_height_in_luma_samples | ue(v) |
| } | |
| nnr_output_colour_description_present_flag /*dual layer output colour space | u(1) |
| where addition happens*/ | |
| if(nnr_output_colour_description_present_flag ) { | |
| nnr_colour_primaries | u(8) |
| nnr_transfer_characteristics | u(8) |
| nnr_matrix_coeffs | u(8) |
| } | |
| /* camera view port information: camera parameters and camera position parameters */ | |
| viewport_camera_info_present_flag | u(1) |
| if (viewport_camera_info_present_flag) { | |
| nnr_num_cameras_minus1 | ue(v) |
| nnr_camera_view_point_info(nnr_num_cameras_minus1 ) | |
| } | |
| /* nnr_base layer information*/ | |
| nnr_bl_idc /*BL is MPI or MVD etc*/ | ue(v) |
| if (nnr_bl_idc = = 0 \|\| nnr_bl_idc = = 1) { /* MPI or MSI: they can use the same | |
| tiling but it affects the input of NN MLP*/ | |
| nnr_mpi_layer_minus1 | ue(v) |
| mpi_tiling_info(nnp_mpi_layer_minus1) | |
| /*How MPI is tiled in pseudo video sequence*/ | |
| /*view rendering required parameters*/ | |
| nnr_sf_value /*σ parameter for view rendering using forward mapping, in units | u(32) |
| of 0.001*/ | |
| depth_representation_info( ) /*signal depth min/max information required for | |
| view rendering. This SEI is in VSEI, HEVC and VVC*/ | |
| } elseif ((nnr_bl_idc = = 2) { /* MVD */ | |
| ... | |
| ... /* MVD-specific parameters */ | |
| } | |
| /* nnr_enhancement layer neural network residue information*/ | |
| nnr_mode_idc /*carry NNC bitstream or external means*/ | ue(v) |
| nnr_input_dimension_minus3 /*MVC case, 1D array, input dimension is 3, MPI | ue(v) |
| 2D array, input dimension is 4, MSI: input dimension is 5, MVD 6DoF: imput | |
| dimension is 6*/ | |
| for ( i = 0; i < nnr_input_dimension_minus3 + 3; i++) | |
| nnr_position_encoding_freq[ i ] /*L: number of freq used for input position | ue(v) |
| coding*/ | |
| /*residue could be negative value: normalize data in [0 1], the syntax in units of 0.001 | |
| */ | |
| nnr_normalized_weight | u(32) |
| nnr_abs_normalized_offset | u(32) |
| if (nnr_abs_normalized_offset != 0) | |
| nnr_sign_normalized_offset | u(1) |
| /*note: optionally, below, one can include input and output formatting information in | |
| NNPFC SEI (note included in this example)*/ | |
| ... | |
| /* Enhancement layer NNR bitstream specified or updated by ISO/IEC 15938-17 | |
| bitstream */ | |
| if( nnr_mode_idc = = 1 ) { | |
| while( !byte_aligned( ) ) | |
| nnr_reserved_zero_bit | u(1) |
| for( i = 0; more_data_in_payload( ); i++ ) | |
| nnr_payload_byte[ i ] | b(8) |
| } | |
| } | |

For the camera viewpoint information, depending on the setup, for a 1D setup, one can use the Multiview acquisition information SEI and Multiview view position SEI in VSEI, HEVC, and AVC. For general setup, one can use the Viewport camera parameters SEI and viewport position SEI in Visual Volumetric Video-based Coding (V3C) (Ref. 11]) and MPEG Immersive video (MIV) (Ref. [12]). An example is shown below in Table 3. It is noted that the following SEIs: multiview_acquisition_info( ), multiview_view_position( ), viewport_camera_parameters( ), and viewport_position( ) do not need to be included in the camera_viewport_info( ) SEI message depicted in Table 3. They can also be sent outside of the camera_viewport_info( ) SEI message. In another embodiment, because a 6DoF (six degrees of freedom) setup includes a 1D setup, one can just always use the 6DoF setup case, but it might require more bits.

TABLE 3
Example camera viewport SEI message

| | Descriptor |
|---|---|
| camera_viewport_info( nnr_num_cameras_minus1 ) { | |
| cv_idc /*0: 1D setup; 1: 6DoF setup*/ | ue(v) |
| if (cv_idc == 0) { /*the following two SEIs are in VSEI, | |
| HEVC, and VVC spec*/ | |
| multiview_acquisition_info( ) | |
| multiview_view_position( ) | |
| } | |
| else if(cv_idc == 1 ) { /*the following two SEIs are in | |
| ISO/IEC 23090-5 spec*/ | |
| for ( i = 0; i <= nnr_num_cameras_minus1; i++) { | |
| viewport_camera_parameters ( ) | |
| viewport_position( ) | |
| } | |
| } | |
| } | |

cv_idc specifies the setup of camera viewpoint information as shown in the following Table.

| cv_idc | camera viewport setup |
|---|---|
| 0 | 1D Horizontal |
| 1 | 6 DoF or general setup |

nnr_purpose_idc specifies the purpose of the neural network residual output. It's a 5-bit on-off signalling, where: the 0^{th} bit signals the PSNR quality enhancement; the 1^{st} bit signals the dynamic range enhancement; the 2^{nd} bit signals the colour gamut enhancement; the 3^{rd} bit signals the spatial resolution enhancement, and the 4^{th} bit signals the temporal frame rate. Each bit can be 0 or 1 and in total there are 2⁵ combinations.

nnr_output_pic_width_in_luma_samples specifies the width, in units of luma samples, of the output picture referring to the SEI.

nnr_output_pic_height_in_luma_samples specifies the height, in units of luma samples, of the output picture referring to the SEI.

Note: the base layer decoded picture resolution can be different from the final output resolution using this SEI.

The following syntax elements are for the colour space where 3D neural network residue layer system can be applied in different colour space than for the coded layer video sequence (CLVS) layer. For example, the bitstream is in YCbCr colour space, where dual layer system can operate on RGB colour space.

nnr_output_colour_description_present_flag equal to 1 indicates that a distinct combination of colour primaries, transfer characteristics, and matrix coefficients for the output picture resulting from the SEI is specified in the SEI message syntax structure. nnr_output_colour_description_present_flag equal to 0 indicates that the combination of colour primaries, transfer characteristics, and matrix coefficients for the output picture resulting from the SEI is the same as indicated in VUI parameters for the CLVS.

nnr_colour_primaries has the same semantics as specified in clause 7.3 for the vui_colour_primaries syntax element, except as follows:
nnr_colour_primaries specifies the colour primaries of the picture resulting from applying the SEI message, rather than the colour primaries used for the CLVS.
When nnr_colour_primaries is not present in the SEI message, the value of nnr_colour_primaries is inferred to be equal to vui_colour_primaries.

nnr_transfer_characteristics has the same semantics as specified in clause 7.3 for the vui_transfer_characteristics syntax element, except as follows:
nnr_transfer_characteristics specifies the transfer characteristics of the picture resulting from applying the SEI message, rather than the transfer characteristics used for the CLVS.
When nnr_transfer_characteristics is not present in the SEI message, the value of nnr_transfer_characteristics is inferred to be equal to vui_transfer_characteristics.

nnr_matrix_coeffs has the same semantics as specified in clause 7.3 for the vui_matrix_coeffs syntax element, except as follows:
nnr_matrix_coeffs specifies the matrix coefficients of the picture resulting from applying the SEI message, rather than the matrix coefficients used for the CLVS.
When nnr_matrix_coeffs is not present in the SEI message, the value of nnr_matrix_coeffs is inferred to be equal to vui_matrix_coeffs.
The values allowed for nnr_matrix_coeffs are not constrained by the chroma format of the decoded video pictures that is indicated by the value of ChromaFormatIdc for the semantics of the VUI parameters.

nnr_num_cameras_minus1 plus 1 specifies the number of viewport cameras.

Below are the semantics for the base layer related information.

nnr_bl_idc specifies the base layer signal input format for a 3D scene representation as follows:

| nnr_bl_idc | base layer input format |
|---|---|
| 0 | MPI |
| 1 | MSI |
| 2 | MVC or MVD |

nnr_mpi_layer_minus1 plus 1 specifies the number of MPI layers of the MPI representation.

nnr_sf_value specifies the scaling factor using for view rendering in units of 0.001.

It is noted that for depth_representation_info( ) it does not need to signal inside the proposed SEI. It can be signaled outside of the current SEI.

Below are the semantics used for the enhancement layer NNR.

nnr_mode_idc equal to 0 specifies that the neural network residue is determined by external means not specified in this Specification. nnr_mode_idc equal to 1 specifies that that the neural network residue is a neural network represented by the ISO/IEC 15938-17 bitstream contained in this SEI message. nnr_mode_idc equal to 2 specifies that the neural network residue is a neural network identified by a specified tag Uniform Resource Identifier (URI) (nnr_uri_tag[i]) and neural network information URI (nnr_uri[i]). The value of nnr_mode_idc shall be in the range of 0 to 255, inclusive. Values of nnr_mode_idc greater than 2 are reserved for future specification by ITU-T|ISO/IEC and shall not be present in bitstreams conforming to this version of this Specification. Decoders conforming to this version of this Specification shall ignore SEI messages that contain reserved values of nnr_mode_idc.

nnr_input_dimension_minus3 plus 3 specifies the input signal dimension.

| base layer input format | nnr_input_dimension |
|---|---|
| MPI 1D | 3 |
| MPI 2D | 4 |
| MSI or 3DoF | 5 |
| MVD | 6 |

nnr_position_encoding_freq[i] specifies the frequency of input position encoding for i-th dimension.

nnr_normalized_weight specifies the weight value in units of 0.001.

nnr_abs_normalized_offset specifies the absolute offset value in units of 0.001.

nnr_sign_normalized_offset specifies the sign of the offset value.

$$nnr\_normalized \_offset = ( ( nnr\_sign \_normalized \_offset >= 0 ) ? 1 : - 1 ) * nnr\_abs \_nomialized \_offset$$

The residue input x to the neural networks is scaled to y in [0 1]: y=(nnr_normalized_weight*x+nnr_normalized_offset)*0.001.

For unbounded scene, it may necessary also to specify the min and max value of pose coordinators and/or depth information (for zoom-in/out effect) to avoid over-rendering. In one example, let the reference camera poses been expressed by (xₛᵢ, yₛᵢ, zₛᵢ) in the camera-to-world coordinating system where i is the index of reference cameras. The reference camera poses form a 3D volume in the 3D space and the min and max values can be calculated by:

$$x\_min = min ( {x}_{s i} ) ; x\_max = max ( {x}_{s i} ) ;$$

$$y\_min = min ( {y}_{s i} ) ; y\_max = max ( {y}_{s i} ) ;$$

$$z\_min = min ( {z}_{s i} ) ; z\_max = max ( {z}_{s i} ) ;$$

When a novel view (xₜ, yₜ, zₜ) is to be rendered, the camera pose of the novel view needs to be bounded within the 3D volume by the min and max values of the reference poses. i.e.,

$${x}_{tb} = min ( x\_max , max ( x\_min , {x}_{t ,} ) ) ;$$

$${y}_{tb} = min ( y\_max , max ( y\_min , {y}_{t ,} ) ) ;$$

$${z}_{tb} = min ( z\_max , max ( z\_min , {z}_{t ,} ) ) ;$$

In another example, scaling factors may be further applied to the min and max values of the reference camera poses to adjust the bounded area.

### REFERENCES

Each one of the references listed herein is incorporated by reference in its entirety.
[1] Yiheng Xie et al., “Neural Fields in Visual Computing and Beyond,” Eurographics 2022/CGF, State-of-the-Art Report, Volume 41 (2022), No. 2, 2022.
[2] Ben Mildenhall et al., “NeRF: Representing Scenes as Neural Radiance Fields for View Synthesis,” ECCV 2020, also in arXiv: 2003.08934v2, 5 Apr. 2022.
[3] Alex Yu et al., “pixelNerF: Neural Radiance Fields from One or Few Images,” CVPR 2021, also in arXiv: 2012.02190v3, 30 May 2021.
[4] Heiner Kirchhoffer et al, “Overview of the Neural Network Compression and Representation (NNR) Standard,” IEEE Trans. on Circuits and Systems for Video Technology, Vol. 32, No. 5, May 2022, pp. 3203˜3216.
[5] Richard Tucker and Noah Snavely, “Single-view view synthesis with multiplane images,” CVPR 2020.
[6] “Test Model 11 of 3D-HEVC and MV-HEVC,” JCT3V-K1003, Geneva, CH, February 2015.
[7] Vincent Sitzmann et al., “Implicit Neural Representations with Periodic Activation Functions,” NeurIPS 2020, also in arXiv: 2006.09661v1, 17 Jun. 2020.
[8] Benjamin Attal et al., “MatryODShka: Real-time 6DoF Video View Synthesis using Multi-Sphere Images,” (ECCV) 2020.
[9] Ben Mildenhall et al., “Local Light Field Fusion: Practical View Synthesis with Prescriptive Sampling Guidelines”, ACM Transactions on Graphics, Vol. 38, No. 4. Article 29, July 2019.
[10] Sean McCarthy et al., “Additional SEI messages for VSEI (Draft 2)”, JVET-AA2006v2, JVET 27^{th} meeting, 13-22 Jul. 2022.
[11] ISO/IEC 23090-5, Information technology-Coded Representation of Immersive Media—Part 5: Visual Volumetric Video-based Coding (V3C) and Video-based Point Cloud Compression (V-PCC).
[12] ISO/IEC 23090-12, Information technology-Coded representation of immersive media—Part 12: MPEG Immersive video.
[13] ISO/IEC 15938-17:2022, “MPEG NNC specification: Information technology—Multimedia content description interface—Part 17: Compression of neural networks for multimedia content description and analysis.”

### Example Computer System Implementation

Embodiments of the present invention may be implemented with a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control, or execute instructions relating to a scalable 3D scene representation, such as those described herein. The computer and/or IC may compute any of a variety of parameters or values that relate to a scalable 3D scene representation described herein. The image and video embodiments may be implemented in hardware, software, firmware and various combinations thereof.

Certain implementations of the invention comprise computer processors which execute software instructions which cause the processors to perform a method of the invention. For example, one or more processors in a display, an encoder, a set top box, a transcoder, or the like may implement methods related to a scalable 3D scene representation as described above by executing software instructions in a program memory accessible to the processors. Embodiments of the invention may also be provided in the form of a program product. The program product may comprise any non-transitory and tangible medium which carries a set of computer-readable signals comprising instructions which, when executed by a data processor, cause the data processor to execute a method of the invention. Program products according to the invention may be in any of a wide variety of non-transitory and tangible forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted. Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (e.g., that is functionally equivalent), including components which are not structurally equivalent to the disclosed structure which performs the function in the illustrated example embodiments of the invention.

### EQUIVALENTS, EXTENSIONS, ALTERNATIVES AND MISCELLANEOUS

Example embodiments that relate to a scalable 3D scene representation are thus described. In the foregoing specification, embodiments of the present invention have been described with reference to numerous specific details that may vary from implementation to implementation. Thus, the sole and exclusive indicator of what is the invention, and what is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. In an encoder, a method to generate a scalable 3D scene representation, the method comprising:
accessing a first set of images in a first format (102) for a scene;
generating a first 3D scene representation (107) for the scene based on the first set of images;
accessing a second set of images in a second format (104) for the scene;
generating a second 3D scene representation (112) for the scene based on the second set of images, wherein the second 3D representation is better than the first 3D scene representation according to one or more quality criteria;
using a set of original viewing positions and a set of novel viewing positions, generating output image residuals (122) based on the first 3D scene representation and the second 3D scene representation;
training a residual neural field network (125) using the output image residuals to generate predicted residual images approximating the output image residuals;
transmitting the first 3D scene representation (107) for the scene as a base layer; and
transmitting information about the trained residual neural field network as an enhancement layer.

2. The method of claim 1, further comprising reformatting outputs of the first 3D scene representation or the second 3D scene representations before generating the image residuals.

3. The method of claim 2, wherein reformatting comprises image upscaling, image downscaling, frame dropping, frame interpolation, or dynamic range/colour gamut extension.

4. The method of claim 1, wherein the one or more quality criteria include PSNR scalability, dynamic range scalability, color gamut scalability, spatial resolution scalability, and temporal frame-rate scalability.

5. The method of claim 1, wherein the first set of images is identical to the second set of images.

6. The method of claim 1, wherein the first set of images differs from the second set of images in terms of dynamic range or bit-depth, color gamut, spatial resolution, or frame rate.

7. The method of claim 1, wherein a 3D scene representation may be one of multiview plus depth (MVD) representation, a multi-plane imaging (MPI) representation, or a neural radiance field (NeRF) neural network representation.

8. The method of claim 5, wherein the first 3D scene representation comprises a first NeRF model and the second 3D scene representation comprises a second NeRF model, wherein the second NeRF model renders better quality images than the first NeRF model, and generating the output image residuals comprises:
$$computing first image residuals {\hat{I}}_{( {t}^{g} )}^{e} = {I}_{( {t}^{g} )}^{g} - {\hat{I}}_{( {t}^{g} )}^{b} ; and$$
$$computing second image residuals {\hat{I}}_{( {t}^{n} )}^{e} = {\hat{I}}_{( {t}^{n} )}^{s} - {\hat{I}}_{( {t}^{n} )}^{b} ,$$
wherein, t^{g} denotes an original camera pose, tⁿ denotes a novel camera pose,
$${\hat{I}}_{( t )}^{b} ( x , y ) = {MLP}_{{Φ}_{b}} ( x , y , z , θ , ϕ ) and$$
$${\hat{I}}_{( t )}^{s} ( x , y ) = {MLP}_{{Φ}_{s}} ( x , y , z , θ , ϕ )$$
denote images rendered based on the first NeRF model and second NeRF model respectively for spatial location (x, y, z) and viewing direction (θ, ϕ), and I₍ₜ_{^{g}}₎^{g} denotes an image in the first set of images.

9. The method of claim 8, wherein during training, parameters of the residual neural field network are generated by optimizing
$${⋀}^{} * arg = min ⊤ ( Φ\_r ) {I}^{⋀} \_ {( ( t ) )}^{⋀} r , {I}^{⋀} \_ {( ( t ) )}^{⋀} e ) ,$$
wherein Φᵣ* denotes an optimum set of the parameters of the residual field network, Î₍ₜ₎^{r}(x, y) denotes an output of the trained residual field network at a view t, Î₍ₜ₎^{e} denotes an image residual at view t, and D( ) denotes a loss function to be minimized during training.

10. In a decoder, a method to generate an output 3D scene, the method comprising:
receiving a base layer bitstream (107) comprising a first 3D scene representation (107) for a scene;
receiving an enhancement layer bitstream (127) comprising information to reconstruct a trained residual neural field network;
given a viewer position:
generating a first 3D output (132) of a scene based on the first 3D scene representation;
generating image residuals (145) using the viewer position and the trained residual neural field network; and
combining the first 3D output of the scene and the image residuals to generate an enhanced 3D output of the scene.

11. The method of claim 10, further comprising reformatting the first 3D output of the scene or the image residuals before combining them.

12. The method of claim 11, wherein reformatting comprises image upscaling, image downscaling, frame dropping or frame interpolation.

13. The method of claim 1, wherein information about the trained residual neural field network comprises one or more of:
a quality parameter specifying the one or more quality criteria (nnr_purpose_idc),
camera viewport information (viewport_camera_info_present_flag parameters),
first model parameters for the first 3D representation (nnr_bl_idc),
the number of hidden layers in the residual neural field,
the input position encoding method (nnr_position_encoding_freq [i]),
the activation function,
parameters related to residual rescaling (nnr_normalized_weight/offset, and nnr_sign_normalized_offset)
descriptors of input coordinate parameters (nnr_input_dimension_minus3), and
descriptors of output parameters (nnr_colour_primaries, nnr_output_pic_width_in_luma_samples, nnr_output_pic_height_in_luma_samples etc).
residual rescaling parameters (nnr_normalized_weight, nnr_abs_normalized_offset, and nnr_sign_normalized_offset).

14. The method of claim 13, wherein the information is transmitted as part of supplemental enhancement information messaging.

15. The method of claim 1, wherein training the residual neural field network (125) using the output image residuals is in a first spatial resolution, and further comprising:
training the residual neural field network with input the output image residuals at a second spatial resolution lower than the first spatial resolution, and with output the predicted residual images at the first spatial resolution.

16. A non-transitory computer-readable storage medium having stored thereon computer-executable instructions for executing with one or more processors a method in accordance with claim 1.

17. An apparatus comprising a processor and configured to perform the methods recited in claim 1.
